(19) United States
(12) Patent Application Publication
(10) Pub. No.: US 2002/0184299 A1
(43) Pub. Date: Dec. 5, 2002

(54) Method for enlarging communication range of bluetooth data

(76) Inventors: Kae-Jy Chou, Taipei Hsien (TW); Shu-Kun Shen, Ho City (TW)

Correspondence Address: SUPREME PATENT SERVICES, POST OFFICE BOX 2339, SARATOGA, CA, 95070, US

(21) Appl. No.: 09/872,969

(22) Filed: Jun. 2, 2001

(51) Int. Cl. G06F 15/16

(52) U.S. Cl. 709/202; 709/203

(57) ABSTRACT

A method for enlarging communication range of bluetooth data applicable to a communication system, comprising at least a client electronic machine, a bluetooth server, and a bluetooth agent. By taking advantage of a Bluetooth Agent Application Profile of the bluetooth agent, the method capable of enlarging communication range of bluetooth data comprises: a searching procedure for the bluetooth agent to search the bluetooth server periodically for related service information; a searching procedure for the client electronic machine to search the bluetooth agent for bluetooth service; a linking procedure for the bluetooth agent to request the bluetooth server for linking after receipt of a link request from the client end; a data transmission procedure; and an unlink procedure.

### FIELD OF THE INVENTION

This invention relates generally to a method for communication of bluetooth data, particularly to a method that can enlarge communication range of bluetooth data.

### BACKGROUND OF THE INVENTION

In a conventional bluetooth communication system composed at least a client electronic machine 01 and a bluetooth server 02 as shown in FIG. 1, the output power of the client machine 01 is usually limited lower than 1 mW for data transmission between the respective hardware equipments 01a, 02a, wherein the signal intensity is 0 dBm and the valid communication distance is about 10 meters.

It is possible to enlarge the valid communication range by raising the transmission power theoretically though, the power consumption at the client end will be soared that may require a relatively larger power supply with a bigger volume accordingly that would contravene the portability trend or the client machine will exhaust very soon and become impracticable. For overcoming such a dilemma, building more bluetooth servers to cover wider service range is a common plan that entails more expenditure however.

### SUMMARY OF THE INVENTION

The primary object of this invention is to provide a method for enlarging communication range of bluetooth data without increasing the transmission power.

Another object of this invention is to provide bluetooth agent service for expanding the service scope of a bluetooth server.

In order to realize abovesaid objects, this invention provides a method for enlarging communication range of bluetooth data applicable to a communication system, comprising at least a client electronic machine, a bluetooth server, and a bluetooth agent. By taking advantage of a Bluetooth Agent Application Profile of the bluetooth agent, the method capable of enlarging communication range of bluetooth data comprises the following procedures:

Executing a searching procedure for the bluetooth agent to search the bluetooth server periodically for related service information and basing thereon to update the service information of the bluetooth server previously stored in the bluetooth agent that enables the client electronic machine to search for the bluetooth service information;

Executing a searching procedure for the client electronic machine to search the bluetooth agent for bluetooth service, wherein the bluetooth agent is to compare and transmit the new bluetooth service information to the client electronic machine immediately upon receipt of a search instruction from the client end;

Executing a linking procedure for the bluetooth agent to request the bluetooth server for linking after receipt of a link request from the client end, and transfer the response signal of the bluetooth server to the client electronic machine;

Executing a data transmission procedure, wherein either an upload or a download bluetooth data pack is transmitted to the bluetooth server or the client electronic machine via the bluetooth agent; and

Executing an unlink procedure, wherein either the client electronic machine or the bluetooth server may request the bluetooth agent to unlink, and the latter will do as wished upon receipt of the request.

By dint of the bluetooth agent of this invention, the data transmission range between a client electronic machine and a bluetooth server can be enlarged to relieve entailment of building expenditure of the bluetooth server.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a schematic view showing the conventional bluetooth communication mode;

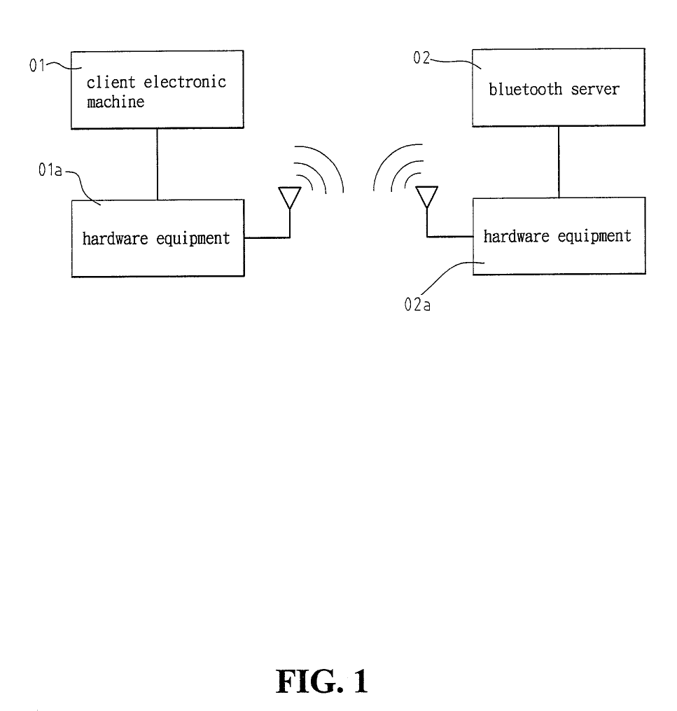

FIG. 2 shows the framework of a bluetooth agent of this invention;

FIG. 3 shows the interaction among the bluetooth agent, a client electronic machine, and a bluetooth server;

FIG. 4 shows the block diagram and internal bus interface of a Bluetooth Agent Application Profile; and

FIG. 5 shows the structure of an agent switch table of the bluetooth agent.

### DETAILED DESCRIPTION OF THE INVENTION

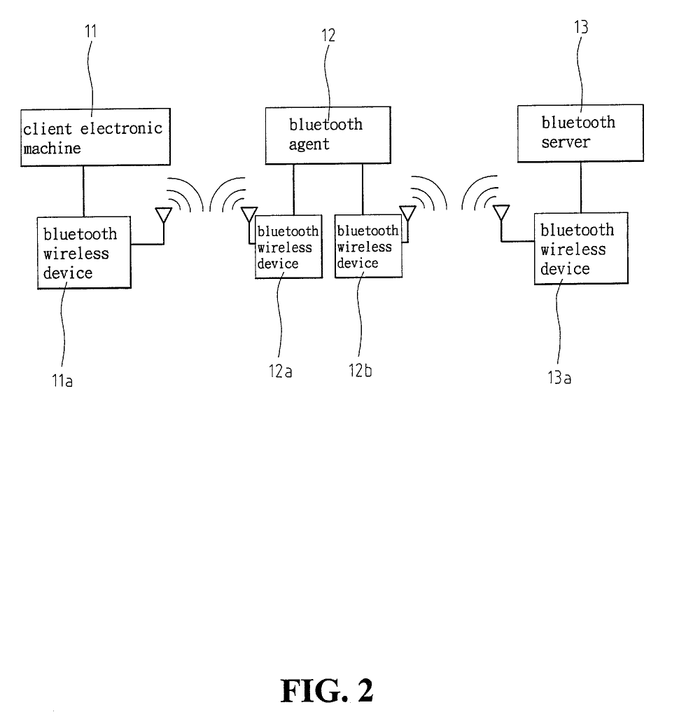

According to a schematic framework of bluetooth agent of this invention shown in FIG. 2, a client electronic machine 11 is to communicate with a bluetooth agent 12 via respective bluetooth wireless devices 11a, 12a for transmitting and receiving a data pack, which is then in turn relayed from the bluetooth agent 12 to a bluetooth server 13 via respective bluetooth wireless devices 12a, 13a to thereby enlarge the communication range of bluetooth data without increasing the transmission power. Abovesaid process is reversible when download of a data pack from the bluetooth server 13 is desired.

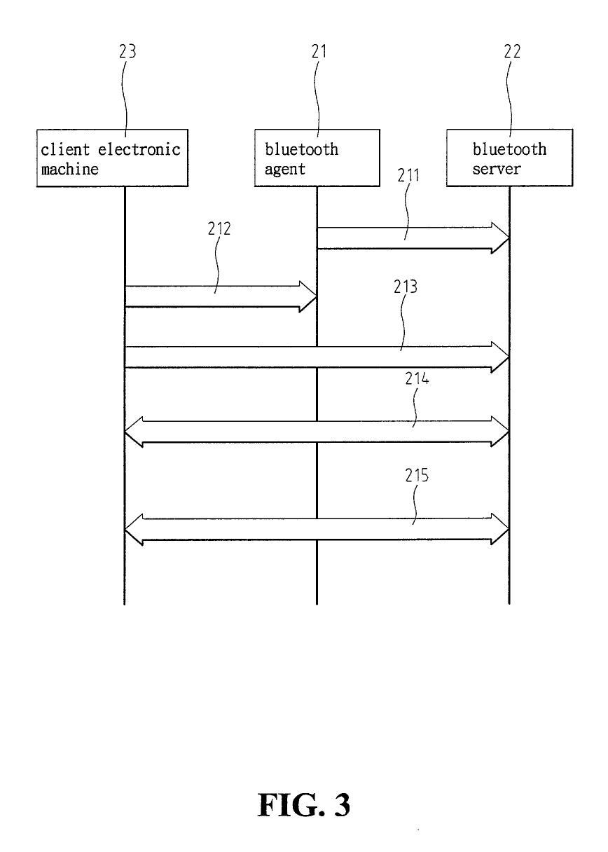

As illustrated in FIG. 3, the interaction among a bluetooth agent 21, a client electronic machine 23, and a bluetooth server 22 comprises five basic procedures from procedure 211 all the way up to procedure 215 when an inside Bluetooth Agent Application Profile in the bluetooth agent 21 is driven to work.

The procedure 211 is a searching procedure for the bluetooth agent 21 to search the bluetooth server 22 periodically for related service information and basing thereon to update the service information of the bluetooth server 22 previously stored in the bluetooth agent 21 that enables the client electronic machine 23 to search for the bluetooth service information.

The procedure 212 is a searching procedure for the client electronic machine 23 to search the bluetooth agent 21 for bluetooth service. After the bluetooth agent 21 has received a search instruction from the client end, it is supposed to compare and transmit the corresponding bluetooth service information to the client electronic machine 23.

The procedure 213 is a linking procedure, wherein the bluetooth agent 21 will request the bluetooth server 22 for linking upon receipt of a link request from the client end, and transfer the response signal to the client electronic machine 23.

The procedure 214 is a data transmission procedure, wherein either an upload or a download bluetooth data pack is transmitted to the bluetooth server 22 or the client electronic machine 23 via the bluetooth agent 21.

The procedure 215 is an unlink procedure, wherein either the client electronic machine 23 or the bluetooth server 22 may request the bluetooth agent 21 to unlink, and the latter will do as wished upon receipt of the request.

By taking advantage of a Bluetooth Generic Access Profile, a Bluetooth Serial Port Profile, a Bluetooth Service Discovery Application Profile, which are known modules in bluetooth communication, the Bluetooth Agent Application Profile can serve as an “Agent Proxy” capable of transferring bluetooth dada and updating bluetooth service information.

The bluetooth agent 21 can work to match a plurality of client electronic machines 23 and bluetooth servers 22, however, for simplification, only one of individual equipments are shown in FIG. 3.

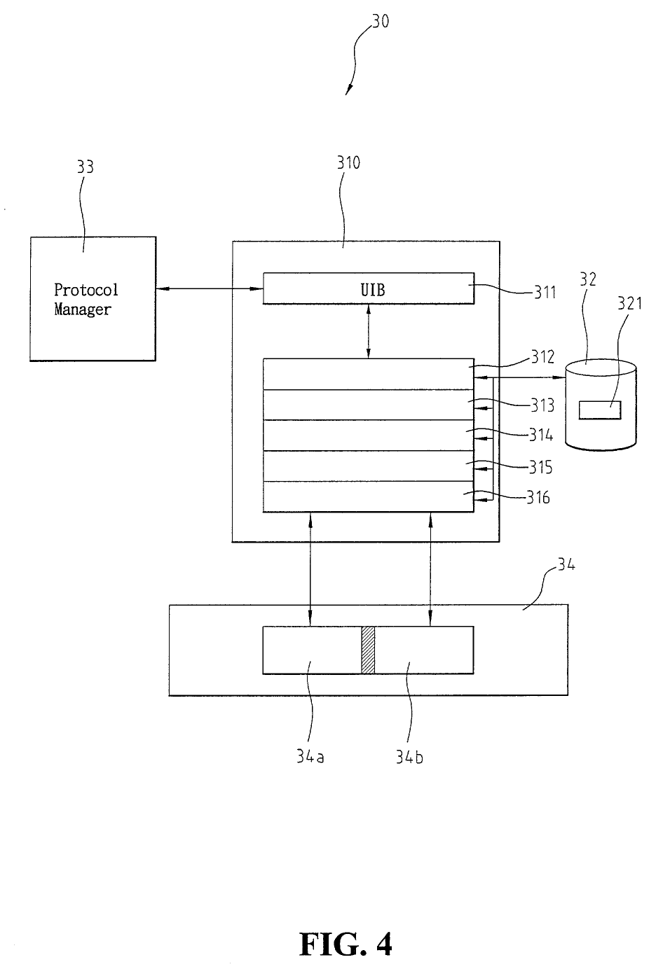

As indicated in FIG. 4—the block diagram and internal bus interface of a bluetooth agent—six basic procedures are to be executed in driving a Bluetooth Agent Application Profile 310, including a User Interface Block (UIB) 311 for operation on a user interface and further control of execution of a plurality of blocks 312, 313, 314, 315 and 316.

The procedure 312 is an Agent Control Block (ACB) of the bluetooth agent playing as a communication bridge between the UIB 311 and the rest blocks 313, 314, 315, and 316, and controlling the latter blocks. Therefore, the ACB 312 is the kernel of the Bluetooth Agent Application Profile in a bluetooth agent 30 of this invention.

The procedure 313 is a Close Connection Block (CCB) employed to interrupt a link operation and close the related Data Link Connection Identifier (DLCI).

The procedure 314 is a Transfer Data Block (TDB) to be activated for data pack transmission via a logic channel 34a, 34b of a bluetooth transmission layer 34 according to an Agent Switch Table 321 recorded in an Agent Switch Database 32 of the bluetooth agent 30.

The procedure 315 is a Create DLCI Connection Block (CDCB) to be performed for linking with a correspondent bluetooth server via the logic channel 34a, 34b of the bluetooth transmission protocol layer 34 according to the Agent Switch Table 321 recorded in the Agent Switch Database 32 of the bluetooth agent 30 when the bluetooth agent 30 receives a link request from a client end.

The procedure 316 is a Server Service Discovery Block (SSDB) for periodically searching service information of bluetooth server in order to update the out-of-date service information of the bluetooth agent 30.

As illustrated in FIG. 4, the Agent Switch Table 321 is included in the Agent Switch Database 32 and employed for recording required information of switching transmission channels when the Bluetooth Agent Application Profile in the bluetooth agent 30 is driven to work. The Agent Switch Database 32 can store a plurality of tables like the Agent Switch Table 321 shown in FIG. 4. Also in FIG. 4, a Protocol Manager 33 is arranged for management of the bluetooth transmission protocol, and in the bluetooth transmission protocol layer 34, the logic channels 34a, 34b in the bluetooth agent are assigned to the client end and the bluetooth server respectively.

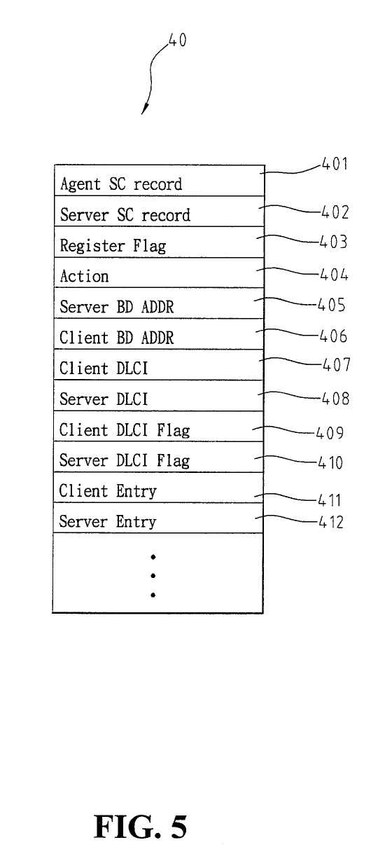

Referring to the structure of Agent Switch Table of the bluetooth agent shown in FIG. 5, an Agent Switch Table 40 is employed to record required information of switching transmission channels when the Bluetooth Agent Application Profile in the bluetooth agent is driven to work, and the Agent Switch Table 40 comprises at least:

an Agent Server Channel (Agent_SC) record 401, including registered server channels in the bluetooth agent, namely, the server channels which the bluetooth agent can provide to the client end and the bluetooth server for linking;

a Server Server Channel (Server_SC) record 402, including the server channels of bluetooth servers connected with the Agent_SC in record 401;

a Register Flag (Register_Flag) 403 for tagging a registered Agent-SC provided to the client end for inquiry with a bluetooth service database in the bluetooth agent to confirm registry of the Agent_SC if the Register_Flag is true, or it is false otherwise;

an Action 404 for showing whether the client end and the bluetooth server have converted data in the bluetooth agent, positive if the value recorded is true, or it is false otherwise;

a Server Bluetooth Device Address (Server_BD_ADDR) record 405 that records the address of a bluetooth server connecting with the Agent_SC;

a Client Bluetooth Device Address (Client_BD_ADDR) record 406 for recording the address of a client end connecting with the Agent_SC;

a Client DLCI (Client_DLCI) record 407 for recording a DLCI (Data Link Connection Identifier) channel through which the client end is connected with the bluetooth agent;

a Server DLCI (Server_DLCI) record 408 for recording a DLCI channel through which the bluetooth server is connected with the bluetooth agent;

a Client DLCI Flag (Client_DLCI_Flag) 409 for discriminating whether a DLCI channel is built between a client end and the bluetooth agent, positive if the flag is true, or false otherwise;

a Server DLCI Flag (Server_DLCI_Flag) 410 to express whether a DLCI channel is built between the bluetooth server and the bluetooth agent, positive if the flag is true, or false otherwise;

a Client Input Data Entry (Client_Entry) record 411 for recording the entry of a bluetooth data pack transmitted from the bluetooth server to a client end via the bluetooth agent; and

a Server Input Data entry (Server_Entry) record 412 for recording the entry of a bluetooth data pack transmitted from a client end to the bluetooth server via the bluetooth agent.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for enlarging communication range of bluetooth data applicable to a communication system composed of at least a client electronic machine, a bluetooth server, and a bluetooth agent, the method comprising the following procedures:
Executing a searching procedure for the bluetooth agent to search the bluetooth server periodically for related service information and basing thereon to update the service information of the bluetooth server previously stored in the bluetooth agent that enables the client electronic machine to search for the bluetooth service information;
Executing a searching procedure for the client electronic machine to search the bluetooth agent for bluetooth service, wherein the bluetooth agent is to compare and transmit the new bluetooth service information to the client electronic machine immediately upon receipt of a search instruction from the client end;
Executing a linking procedure for the bluetooth agent to request the bluetooth server for linking after receipt of a link request from the client end, and transfer the response signal of the bluetooth server to the client electronic machine;
Executing a data transmission procedure, wherein either an upload or a download bluetooth data pack is transmitted to the bluetooth server or the client electronic machine via the bluetooth agent; and
Executing an unlink procedure, wherein either the client electronic machine or the bluetooth server may request the bluetooth agent to unlink, and the latter will do as wished upon receipt of the request.

2. The method according to claim 1, wherein the bluetooth agent proceeds the linking and the data transmission procedure in a bluetooth communication protocol RFCOMM layer and performs data transmission or data transference through a plurality of protocol logic channels, wherein the logic channel is defined as a Data Link Connection Identifier (DLCI) channel.

3. The method according to claim 1, wherein the bluetooth agent comprises at least a Bluetooth Generic Access Profile, a Bluetooth Serial Port Profile, a Bluetooth Service Discovery Application Profile, and a Bluetooth Agent Application Profile.

4. The method according to claim 3, wherein the Bluetooth Agent Application Profile can serve as an “Agent Proxy” for data transmission and updating by taking advantage of the Bluetooth Generic Access Profile, the Bluetooth Serial Port Profile, and the Bluetooth Service Discovery Application Profile, and the Bluetooth Agent Application Profile further comprises:
a User Interface Block (UIB) for operation on a user interface and further control of execution of the rest blocks; and
an Agent Control Block (ACB) being the kernel of the Bluetooth Agent Application Profile in charge of communicating the UIB with a Close Connection Block (CCB), a Transfer Data Block (TDB), a Create DLCI Connection Block (CDCB), and a Server Service Discovery Block (SSDB) and controlling the latter blocks, wherein the Close Connection Block (CCB) is planned to interrupt a link operation or close the related Data Link Connection Identifier (DLCI); the Transfer Data Block (TDB) is activated to transmit a bluetooth data pack according to a switch channel table in the bluetooth agent; the Create DLCI Connection Block (CDCB) is arranged to perform linking with a correspondent bluetooth server in response to a request from a client end; the Server Service Discovery Block (SSDB) is planned for periodically searching service information of bluetooth server in order to update the out-of-date service information of the bluetooth agent.

5. The method according to claim 4, wherein a bluetooth data pack is transmitted basing an Agent Switch Table stored in the bluetooth agent and the Agent Switch Table comprises at least:
an Agent Server Channel (Agent_SC) record, which is a registry record of server channels in the bluetooth agent, namely, the server channels which the bluetooth agent can provide to the client end and the bluetooth server for linking;
a Server Server Channel (Server_SC) record, which shows the server channels of the bluetooth servers connected with the Agent_SC;
a Register Flag (Register_Flag) for tagging a registered Agent-SC provided to the client end for inquiry with a bluetooth service database in the bluetooth agent to confirm registry of the Agent_SC if the Register_Flag is true, or it is false otherwise;
an Action record showing that whether the client end and the bluetooth server have converted data in the bluetooth agent, and it is positive if the value recorded is true, or false otherwise;
a Server Bluetooth Device Address (Server_BD_ADDR) record showing the address of a bluetooth server connecting with the Agent_SC;
a Client Bluetooth Device Address (Client_BD_ADDR) record showing the address of a client end connecting with the Agent_SC;
a Client DLCI (Client_DLCI) record showing a DLCI (Data Link Connection Identifier) channel through which the client end is connected with the bluetooth agent;
a Server DLCI (Server_DLCI) record showing a DLCI channel through which the bluetooth server is connected with the bluetooth agent;
a Client DLCI Flag (Client_DLCI_Flag) for discriminating whether a DLCI channel is built between a client end and the bluetooth agent, and it is positive if the flag is true, or false otherwise;
a Server DLCI Flag (Server_DLCI_Flag) expressing whether a DLCI channel is built between the bluetooth server and the bluetooth agent, and it is positive if the flag is true, or false otherwise;
a Client Input Data Entry (Client_Entry) record showing the entry of a bluetooth data pack transmitted from the bluetooth server to a client end via the bluetooth agent; and
a Server Input Data entry (Server_Entry) record showing the entry of a bluetooth data pack transmitted from a client end to the bluetooth server via the bluetooth agent.
